(19) United States
(12) Patent Application Publication
(10) Pub. No.: US 2023/0191507 A1
(43) Pub. Date: Jun. 22, 2023

(54) ALLOY TOOL BIT TWIST DRILL

(71) Applicants: SHANDONG XINGONG CUTTING TOOLS CO. LTD, Shandong (CN); SHANDONG OLD ROUGHNECK MACHINERY TECHNOLOGY CO. LTD, Shandong (CN)

(72) Inventor: Shiqing LI, Shandong (CN)

(21) Appl. No.: 17/925,466

(22) PCT Filed: May 12, 2021
(86) PCT No.: PCT/CN2021/000099

§ 371 Date: Nov. 15, 2022

(30) Foreign Application Priority Data
May 17, 2020 (CN) 202010428077.4
May 17, 2020 (CN) 202010428078.9
May 17, 2020 (CN) 202010428080.6
May 17, 2020 (CN) 202010428122.6
May 17, 2020 (CN) 202010428124.5
May 17, 2020 (CN) 202010428157.X
May 17, 2020 (CN) 202010428158.4
May 17, 2020 (CN) 202010428191.7

(51) Int. Cl. B23B 51/02

(52) U.S. Cl. CPC B23B 51/02

(57) ABSTRACT

An alloy tool bit twist drill, comprising a tool shank, a spiral tool body and an alloy tool bit . A groove is milled on a spiral cutting surface of the spiral tool body, the alloy tool bit is integrally arranged on the spiral cutting surface, the spiral cutting surface and a cutting surface of the alloy tool bitare arranged in the same groove, and a central stepped platform is arranged on the cutting surface near the axis center of the alloy tool bit. A central stepped surfaceis arranged on the inner side of the central stepped platform protruding in the rotating direction; or a branch hole table and a branch cutting surface are concavely arranged on the cutting surface of the alloy tool bitin a stepwise manner.

### TECHNICAL FIELD

The present disclosure relates to an alloy tool bit twist drill. The alloy tool bit twist drill is used in a drilling and milling process of machining and bench worker maintenance. The new machining theories consider that the cutting efficiency of a segmented stepwise cutting edge is high. However, after the stepwise cutting edge is gradually extended, the effect of the stepwise cutting edge is obviously reduced. Therefore, the theories are still not truly correct theories.

### BACKGROUND

At present, the drilling tool used in machining is composed of a chisel edge, a cutting edge, a spiral cutting edge and a side edge. The cutting edge is located on a spiral cutting surface and is of a single co-located cutting structure. The cutting edge is in the centrifugal force conduction range of rotary cutting. The cutting edge is subjected to rotary cutting force and centrally outward conduction force at the same time. The cutting edge at the intersection of the cutting edge and the spiral cutting edge is always easy to damage under the action of double forces. An existing hole machining tool swings due to the fact that the structure is not absolutely balanced during drilling. The spiral cutting surface and the spiral cutting edge are damaged due to the fact that the tool is stabilized only through the spiral cutting surface. People generally think that the smoother the surface is, the higher the strength is. According to new theories, the strength of the surface with tiny gaps is higher, but essential structural characteristics of the substance are not revealed, so that the existing hole machining tool is low in efficiency, easy to damage, low in stability and low in drilling precision.

### SUMMARY

The present disclosure aims to provide an alloy tool bit twist drill in view of the above-mentioned problems. The tool has the function of blocking conduction force, and is high in heat dissipation efficiency and strength and long in service life. The tool is easy to position in the drilling process, and the drilling precision is high. People generally thought that the smoother the surface is, the higher the strength is. According to new theories in recent years, the strength of the surface with tiny gaps is higher, but essential structural characteristics of the substance are not revealed. Under the condition that two solids are the same in volumes, the surface area of the dispersed small-volume solid is larger than the surface area of the whole solid. When the whole structure of the solid reaches a certain volume limit, even diamond is broken. The sum of the stress strengths of the small-size solids is far larger than the stress strength of the whole solid under the condition of volume stress. Experiments verify that on a cutting tool in a conventional physical state, the millimeter magnitude has the most obvious high-strength characteristic, namely the millimeter strength. The alloy tool bit twist drill is applied in millimeter strength.

In order to achieve the above purpose, the present disclosure adopts the following technical schemes.

An alloy tool bit twist drill, comprising a tool shank, a spiral tool body and an alloy tool bit, wherein the alloy tool bit twist drill is integrally provided with at least two spiral tool bodies, the surface of each spiral tool body in the cutting direction is a spiral cutting surface, the surface on the outer side of the backward spiral cutting surface in the rotating direction is a spiral pair cutting surface, the spiral cutting surface is intersected with the spiral pair cutting surface to form a spiral cutting edge, the surface on the back side of the axial front end of the spiral cutting surface is a rear cutting surface, the rear cutting surfaces on at least two sides are intersected to form a chisel edge, the spiral cutting surface is intersected with the rear cutting surface to form a cutting edge, and the spiral pair cutting surface is intersected with the rear cutting surface to form a side edge;

the alloy tool bit twist drill is integrally composed of the tool shank and the spiral tool body, a groove is milled on the front spiral cutting surface of the spiral tool body, an alloy tool bit is integrally arranged on the front spiral cutting surface, the spiral cutting surfaces on the two sides and a cutting surface of the alloy tool bit are arranged in the same groove respectively, the spiral cutting edge extends to the alloy tool bit to form a pair cutting edge, and the spiral pair cutting surface extends to the alloy tool bit to form a pair cutting surface;

a central stepped platform is arranged on the cutting surface near the axial center of the alloy tool bit of the alloy tool bit twist drill in a standing mode; a central stepped surface is arranged on the inner side of the central stepped platform protruding in the rotating direction; the central stepped platform is intersected with the rear cutting surface to form a side micro edge; the central stepped platform is intersected with the central stepped surface to form a central edge; and

the width of the central stepped surface on the alloy tool bit is from the axial center to the cutting surface which is smaller than or equal to one third of the radius of the alloy tool bit twist drill.

An alloy tool bit twist drill, comprising a tool shank, a spiral tool body and an alloy tool bit, wherein the alloy tool bit twist drill is integrally provided with at least two spiral tool bodies, the surface of each spiral tool body in the cutting direction is a spiral cutting surface, the surface on the outer side of the backward spiral cutting surface in the rotating direction is a spiral pair cutting surface, the spiral cutting surface is intersected with the spiral pair cutting surface to form a spiral cutting edge, the surface on the back side of the axial front end of the spiral cutting surface is a rear cutting surface, the rear cutting surfaces on at least two sides are intersected to form a chisel edge, the spiral cutting surface is intersected with the rear cutting surface to form a cutting edge, and the spiral pair cutting surface is intersected with the rear cutting surface to form a side edge;

the alloy tool bit twist drill is integrally composed of the tool shank and the spiral tool body, a groove is milled on the front spiral cutting surface of the spiral tool body, an alloy tool bit is integrally arranged on the front spiral cutting surface, the spiral cutting surfaces on the two sides and a cutting surface of the alloy tool bit are arranged in the same groove respectively, the spiral cutting edge extends to the alloy tool bit to form a pair cutting edge, and the spiral pair cutting surface extends to the alloy tool bit to form a pair cutting surface;

a branch hole table is concavely arranged on the cutting surface of the pair cutting edge on the alloy tool bit of the alloy tool bit twist drill in a stepwise manner from the axial center to the outer periphery; the inner side of the branch hole table protrudes to form a branch cutting surface, the branch cutting surface is intersected with the rear cutting surface to form the cutting edge; the branch hole table is intersected with the rear cutting surface to form a side micro edge; the branch hole table is intersected with the cutting surface protruding on the inner side to form a branch cutting edge; and

the branch cutting surface is from the axial center to the cutting surface which is lager than or equal to one third of the radius of the alloy tool bit twist drill and smaller than or equal to two thirds of the radius of the alloy tool bit twist drill.

An alloy tool bit twist drill, comprising a tool shank, a spiral tool body and an alloy tool bit, wherein the alloy tool bit twist drill is integrally provided with at least two spiral tool bodies, the surface of each spiral tool body in the cutting direction is a spiral cutting surface, the surface on the outer side of the backward spiral cutting surface in the rotating direction is a spiral pair cutting surface, the spiral cutting surface is intersected with the spiral pair cutting surface to form a spiral cutting edge, the surface on the back side of the axial front end of the spiral cutting surface is a rear cutting surface, the rear cutting surfaces on at least two sides are intersected to form a chisel edge, the spiral cutting surface is intersected with the rear cutting surface to form a cutting edge, and the spiral pair cutting surface is intersected with the rear cutting surface to form a side edge;

the alloy tool bit twist drill is integrally composed of the tool shank and the spiral tool body, a groove is milled on the front spiral cutting surface of the spiral tool body, an alloy tool bit is integrally arranged on the front spiral cutting surface, the spiral cutting surfaces on the two sides and a cutting surface of the alloy tool bit are arranged in the same groove respectively, the spiral cutting edge extends to the alloy tool bit to form a pair cutting edge, and the spiral pair cutting surface extends to the alloy tool bit to form a pair cutting surface;

a micro cutting surface is concavely formed on the cutting surface of the alloy tool bit from the pair cutting edge toward the axial center direction on the cutting surface of the alloy tool bit of the alloy tool bit twist drill; a micro-strengthening stress extension table is formed on the inner side of the micro cutting surface in a standing mode; the micro cutting surface is intersected with the pair cutting surface on the outer periphery to form a micro cutting edge; the micro cutting surface is intersected with the rear cutting surface to form a cutting micro edge; and the micro-strengthening stress extension table is intersected with the rear cutting surface to form a side micro edge.

An alloy tool bit twist drill, comprising a tool shank, a spiral tool body and an alloy tool bit, wherein the alloy tool bit twist drill is integrally provided with at least two spiral tool bodies, the surface of each spiral tool body in the cutting direction is a spiral cutting surface, the surface on the outer side of the backward spiral cutting surface in the rotating direction is a spiral pair cutting surface, the spiral cutting surface is intersected with the spiral pair cutting surface to form a spiral cutting edge, the surface on the back side of the axial front end of the spiral cutting surface is a rear cutting surface, the rear cutting surfaces on at least two sides are intersected to form a chisel edge, the spiral cutting surface is intersected with the rear cutting surface to form a cutting edge, and the spiral pair cutting surface is intersected with the rear cutting surface to form a side edge;

the alloy tool bit twist drill is integrally composed of the tool shank and the spiral tool body, a groove is milled on the front spiral cutting surface of the spiral tool body, an alloy tool bit is integrally arranged on the front spiral cutting surface, the spiral cutting surfaces on the two sides and a cutting surface of the alloy tool bit are arranged in the same groove respectively, the spiral cutting edge extends to the alloy tool bit to form a pair cutting edge, and the spiral pair cutting surface extends to the alloy tool bit to form a pair cutting surface;

a central stepped platform is arranged on the cutting surface near the axial center of the alloy tool bit of the alloy tool bit twist drill in a standing mode; a central stepped surface is arranged on the inner side of the central stepped platform protruding in the rotating direction; the central stepped platform is intersected with the rear cutting surface to form a side micro edge; the central stepped platform is intersected with the central stepped surface to form a central edge; and

a branch hole table is concavely arranged on the cutting surface of the pair cutting edge on the alloy tool bit of the alloy tool bit twist drill in a stepwise manner from the axial center to the outer periphery integrally; the inner side of the branch hole table protrudes to form a branch cutting surface, the branch cutting surface is intersected with the rear cutting surface to form the cutting edge; the branch hole table is intersected with the rear cuttingsurface to form a side micro edge; the branch hole table is intersected with the cutting surface protruding on the inner side to form a branch cutting edge.

An alloy tool bit twist drill, comprising a tool shank, a spiral tool body and an alloy tool bit, wherein the alloy tool bit twist drill is integrally provided with at least two spiral tool bodies, the surface of each spiral tool body in the cutting direction is a spiral cutting surface, the surface on the outer side of the backward spiral cutting surface in the rotating direction is a spiral pair cutting surface, the spiral cutting surface is intersected with the spiral pair cutting surface to form a spiral cutting edge, the surface on the back side of the axial front end of the spiral cutting surface is a rear cutting surface, the rear cutting surfaces on at least two sides are intersected to form a chisel edge, the spiral cutting surface is intersected with the rear cutting surface to form a cutting edge, and the spiral pair cutting surface is intersected with the rear cutting surface to form a side edge;

the alloy tool bit twist drill is integrally composed of the tool shank and the spiral tool body, a groove is milled on the front spiral cutting surface of the spiral tool body, an alloy tool bit is integrally arranged on the front spiral cutting surface, the spiral cutting surfaces on the two sides and a cutting surface of the alloy tool bit are arranged in the same groove respectively, the spiral cutting edge extends to the alloy tool bit to form a pair cutting edge, and the spiral pair cutting surface extends to the alloy tool bit to form a pair cutting surface;

a central stepped platform is arranged on the cutting surface near the axial center of the alloy tool bit of the alloy tool bit twist drill in a standing mode; a central stepped surface is arranged on the inner side of the central stepped platform protruding in the rotating direction; the central stepped platform is intersected with the rear cutting surface to form a side micro edge; the central stepped platform is intersected with the central stepped surface to form a central edge; and

a micro cutting surface is concavely formed on the cutting surface of the alloy tool bit from the pair cutting edge toward the axial center direction on the cutting surface of the alloy tool bit of the alloy tool bit twist drill integrally; a micro-strengthening stress extension table is formed on the inner side of the micro cutting surface in a standing mode; the micro cutting surface is intersected with the pair cutting surface on the outer periphery to form a micro cutting edge; the micro cutting surface is intersected with the rear cutting surface to form a cutting micro edge; and the micro-strengthening stress extension table is intersected with the rear cutting surface to form a side micro edge.

An alloy tool bit twist drill, comprising a tool shank, a spiral tool body and an alloy tool bit, wherein the alloy tool bit twist drill is integrally provided with at least two spiral tool bodies, the surface of each spiral tool body in the cutting direction is a spiral cutting surface, the surface on the outer side of the backward spiral cutting surface in the rotating direction is a spiral pair cutting surface, the spiral cutting surface is intersected with the spiral pair cutting surface to form a spiral cutting edge, the surface on the back side of the axial front end of the spiral cutting surface is a rear cutting surface, the rear cutting surfaces on at least two sides are intersected to form a chisel edge, the spiral cutting surface is intersected with the rear cutting surface to form a cutting edge, and the spiral pair cutting surface is intersected with the rear cutting surface to form a side edge;

the alloy tool bit twist drill is integrally composed of the tool shank and the spiral tool body, a groove is milled on the front spiral cutting surface of the spiral tool body, an alloy tool bit is integrally arranged on the front spiral cutting surface, the spiral cutting surfaces on the two sides and a cutting surface of the alloy tool bit are arranged in the same groove respectively, the spiral cutting edge extends to the alloy tool bit to form a pair cutting edge, and the spiral pair cutting surface extends to the alloy tool bit to form a pair cutting surface;

a branch hole table is concavely arranged on the cutting surface of the pair cutting edge on the alloy tool bit of the alloy tool bit twist drill in a stepwise manner from the axial center to the outer periphery; the inner side of the branch hole table protrudes to form a branch cutting surface, the branch cutting surface is intersected with the rear cutting surface to form the cutting edge; the branch hole table is intersected with the rear cutting surface to form a side micro edge; the branch hole table is intersected with the cutting surface protruding on the inner side to form a branch cutting edge; and

a micro cutting surface is concavely formed on the cutting surface of the alloy tool bit from the pair cutting edge toward the axial center direction on the cutting surface of the alloy tool bit of the alloy tool bit twist drill integrally; a micro-strengthening stress extensiontable is formed on the inner side of the micro cutting surface in a standing mode; the micro cutting surface is intersected with the pair cutting surface on the outer periphery to form a micro cutting edge; the micro cutting surface is intersected with the rear cutting surface to form a cutting micro edge; and the micro-strengthening stress extension table is intersected with the rear cutting surface to form a side micro edge.

An alloy tool bit twist drill, comprising a tool shank, a spiral tool body and an alloy tool bit, wherein the alloy tool bit twist drill is integrally provided with at least two spiral tool bodies, the surface of each spiral tool body in the cutting direction is a spiral cutting surface, the surface on the outer side of the backward spiral cutting surface in the rotating direction is a spiral pair cutting surface, the spiral cutting surface is intersected with the spiral pair cutting surface to form a spiral cutting edge, the surface on the back side of the axial front end of the spiral cutting surface is a rear cutting surface, the rear cutting surfaces on at least two sides are intersected to form a chisel edge, the spiral cutting surface is intersected with the rear cutting surface to form a cutting edge, and the spiral pair cutting surface is intersected with the rear cutting surface to form a side edge;

the alloy tool bit twist drill is integrally composed of the tool shank and the spiral tool body, a groove is milled on the front spiral cutting surface of the spiral tool body, an alloy tool bit is integrally arranged on the front spiral cutting surface, the spiral cutting surfaces on the two sides and a cutting surface of the alloy tool bit are arranged in the same groove respectively, the spiral cutting edge extends to the alloy tool bit to form a pair cutting edge, and the spiral pair cutting surface extends to the alloy tool bit to form a pair cutting surface;

a central stepped platform is arranged on the cutting surface near the axial center of the alloy tool bit of the alloy tool bit twist drill in a standing mode; a central stepped surface is arranged on the inner side of the central stepped platform protruding in the rotating direction; the central stepped platform is intersected with the rear cutting surface to form a side micro edge; the central stepped platform is intersected with the central stepped surface to form a central edge;

a branch hole table is concavely arranged on the cutting surface of the pair cutting edge on the alloy tool bit of the alloy tool bit twist drill in a stepwise manner from the axialcenter to the outer periphery integrally; the inner side of the branch hole table protrudes to form a branch cutting surface, the branch cutting surface is intersected with the rear cutting surface to form the cutting edge; the branch hole table is intersected with the rear cutting surface to form a side micro edge; the branch hole table is intersected with the cutting surface protruding on the inner side to form a branch cutting edge;

a micro cutting surface is concavely formed on the cutting surface of the alloy tool bit from the pair cutting edge toward the axial center direction on the cutting surface of the alloy tool bit of the alloy tool bit twist drill integrally; a micro-strengthening stress extension table is formed on the inner side of the micro cutting surface in a standing mode; the micro cutting surface is intersected with the pair cutting surface on the outer periphery to form a micro cutting edge; the micro cutting surface is intersected with the rear cutting surface to form a cutting micro edge; and the micro-strengthening stress extension table is intersected with the rear cutting surface to form a side micro edge.

Preferably, at least one or more notch edges are arranged on an alloy tool bit cutting edge of the alloy tool bit twist drill; and each notch edge extends toward the rear cutting surface to form a groove.

Preferably, at least one or more standing steps and at least one or more protruding rear cutting surfaces are arranged on the rear cutting surface where the alloy tool bit of the alloy tool bit twist drill is located from the axial center in such a manner that the height of the rear cutting surface in the direction of an outer side edge is reduced, the standing step is intersected with the cutting surface at the front end in the rotating direction to form at least one or more standing step edges, and the at least one or more protruding rear cutting surfaces are intersected with the cutting surface at the front end in the rotating direction to form at least one or more protruding cutting edges.

Preferably, at least one or more standing steps and at least one or more protruding rear cutting surfaces are arranged on the rear cutting surface where the alloy tool bit of the alloy tool bit twist drill is located from the axial center in such a manner that the height of the rear cutting surface in the direction of an outer side edge is reduced, the at least one or more standing steps are intersected with the cutting surface at the front end in the rotating direction to form at least one or more standing step edges, and the at least one or protruding rear cutting surfaces are intersected with the cutting surface to form at least one protruding cutting edges; and at least one or more notch edges are arranged on the at least one or more stepwise alloy tool bit cutting edges, and each notch edge extends toward the rear cutting surface to form a groove.

Preferably, the rear cutting surfaces on the two sides of the front end of the alloy tool bit of the alloy tool bit twist drill are intersected at the axial center to form a chamfer surface, a chamfer edge and a chisel edge.

Preferably, the rear cutting surfaces on the two sides of the front end of the alloy tool bit of the alloy tool bit twist drill are intersected at the axial center to form a chamfer surface, a chamfer edge and a sharp edge without a chisel edge.

Preferably, cooling holes are integrally formed in a tool shank and a spiral tool body of the alloy tool bit twist drill.

Preferably, the included angle formed by intersecting the cutting edge on the outermost side of the alloy tool bit of the alloy tool bit twist drill with the spiral pair cutting edge is an acute angle; or the included angle formed by intersecting the cutting edge on the outermost side of the alloy tool bit of the alloy tool bit twist drill with the spiral pair cutting edge is a right angle; or the included angle formed by intersecting the cutting edge on the outermost side of the alloy tool bit of the alloy tool bit twist drill with the spiral pair cutting edge is an obtuse angle.

Preferably, a tool shank of the alloy tool bit twist drill is a straight shank; or a tool shank of the alloy tool bit twist drill is a taper shank.

The alloy tool bit twist drill has the following beneficial effects.

In a contrast experiment carried out on a drilling machine, a twist drill with the diameter of 20.0 is used for the experiment. Heat treatment and production in the same batch are carried out at the same time. A drilling object is a forged and tempered gear finish turning machining value, the drilling depth is 35 mm, and blind holes are formed. Under the condition that the rotating speed and the feed amount of an alloy head twist drill with a common structure reach the limit, the rotating speed of the alloy tool bit twist drill can be increased by 40%, the feed amount is improved by 40%, and the comprehensive drilling efficiency is improved by more than one time. The number of drilling holes in the alloy tool bit twist drill is increased by more than ten times compared with that of a twist drill with a common structure.

### BRIEF DESCRIPTION OF THE DRAWINGS

The technical schemes and advantages of the present disclosure are explained in detail by reference to the attached figures.

FIG. 1 is a schematic diagram of an alloy tool bit twist drill in the first embodiment of the present disclosure.

FIG. 2 is a schematic diagram of an alloy tool bit twist drill in the second embodiment of the present disclosure.

FIG. 3 is a schematic diagram of an alloy tool bit twist drill in the third embodiment of the present disclosure.

FIG. 4 is a schematic diagram of an alloy tool bit twist drill in the fourth embodiment of the present disclosure.

FIG. 5 is a schematic diagram of an alloy tool bit twist drill in the fifth embodiment of the present disclosure.

### DETAILED DESCRIPTION OF THE EMBODIMENTS

Preferred embodiments of the alloy tool bit twist drill in the present disclosure are described in detail with reference to the attached figures. In the first embodiment to the seventh embodiment, the alloy tool bit twist drill is mainly described as an example of a tool with two spiral tool bodies integrally.

### Embodiment I

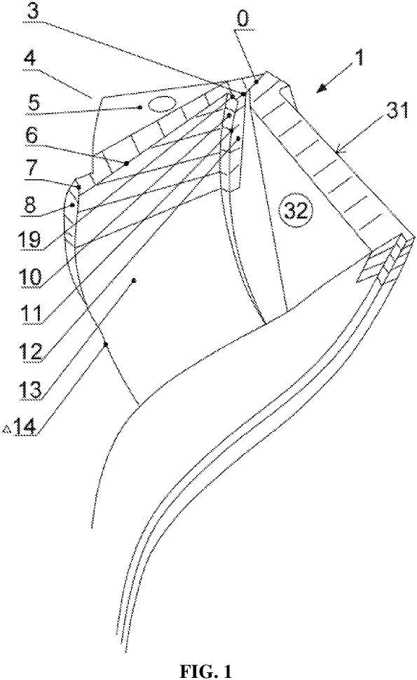

As shown in FIG. 1, the alloy tool bit twist drill 1 in the second embodiment of the present disclosure is comprehensively applied on the basis of the first embodiment, and relates to a drilling tool for machining. The alloy tool bit twist drill is integrally composed of a tool shank (not shown) comprising a taper shank or a straight shank, and a spiral tool body 4. Grooves are milled on the front spiral cutting surfaces of at least two spiral tool bodies 4, and an alloy tool bit 31 is arranged on the front spiral cutting surface integrally or in a connected mode. A cutting surface 13 at the front end in the rotating direction is integrally formed on the alloy tool bit 31 along the axial center of the alloy tool bit twist drill 1. The spiral cutting surfaces 13 integrally arranged on the two sides of the two spiral tool bodies 4 and the two cutting surfaces 13 integrally arranged with the alloy tool bit 31 are arranged in the same groove respectively.

The alloy cutter bit twist drill 1 is integrally provided with two spiral tool bodies 4. The surface of the alloy tool bit 31 of each spiral tool body 4 in the cutting direction is a cutting surface. The surface on the outer side of the backward cutting surface 13 in the rotating direction is a pair cutting surface 8. The cutting surface 13 is intersected with the pair cutting surface 8 to form a spiral cutting edge. The surface on the back side of the axial front end of the cutting surface 13 is a rear cutting surface 5. The rear cutting surfaces on at least two sides are intersected to form a chisel edge. The two ends of the chisel edge are chamfered to form a chamfer surface 22 and a chamfer edge 2. The cutting surface 13 is intersected with the rear cutting surface 5 to form a cutting edge 6. The pair cutting surface 8 is intersected with the rear cutting surface 5 to form a side edge 7. The spiral cutting edge 14 extends to the alloy tool bit 3 to form a pair cutting edge. The spiral pair cutting surface 8 extends to the alloy tool bit 31 to form a pair cutting surface 8 of the alloy tool bit 31.

Near the axial center O on the inner side of the cutting surface 13 of the alloy tool bit 31 of the alloy tool bit twist drill 1, a central stepped platform 10 with millimeter strength is arranged in a standing mode and a central stepped surface 12 is arranged in a protruding mode. The central stepped platform 10 with millimeter strength is connected to the cutting surface 13 of the alloy tool bit 31 in a standing mode. The central stepped platform 10 with millimeter strength on the alloy tool bit 31 is intersected with the central stepped surface 12 to form a central edge 11 with millimeter strength. The central stepped platform 10 with millimeter strength on the alloy tool bit 31 and the front end of the central stepped surface 12 extending along the axial direction are intersected with the rear cutting surface 5 to form a side micro edge 19 and a cutting middle edge 3. The width of the central stepped surface 12 on the alloy tool bit 31 is from the axial center to the cutting surface 13 which is smaller than or equal to one third of the radius of the alloy tool bit twist drill 1.

Through the arrangement, process holes are formed firstly and then drilling is conducted in the drilling process. Due to the fact that the process holes are formed in the same tool, high stability is achieved. Compared with a common reamer, the tool has the advantages of being more stable and efficient.

In a contrast experiment carried out on a drilling machine, a twist drill with the diameter of 20.5 is used for the experiment. Heat treatment and production in the same batch are carried out at the same time on the same material of hard alloy. A drilling object is a forged and tempered gear finish turning machining value, the drilling depth is 35 mm, and blind holes are formed. Under the condition that the rotating speed and the feed amount of a hard alloy tool bit twist drill with a common structure reach the limit, the rotating speed of the alloy tool bit twist drill 1 in the present disclosure can be increased by 40%, the feed amount is improved by 40%, and the comprehensive drilling efficiency is improved by 0.96 time. 731 drilling holes are formed in the alloy tool bit twist drill 1 with a common structure. 7698 drilling holes are formed in the alloy tool bit twist drill 1. The number of drilling holes in the alloy tool bit twist drill is increased by more than ten times compared with that of a twist drill with a common structure.

### Embodiment II

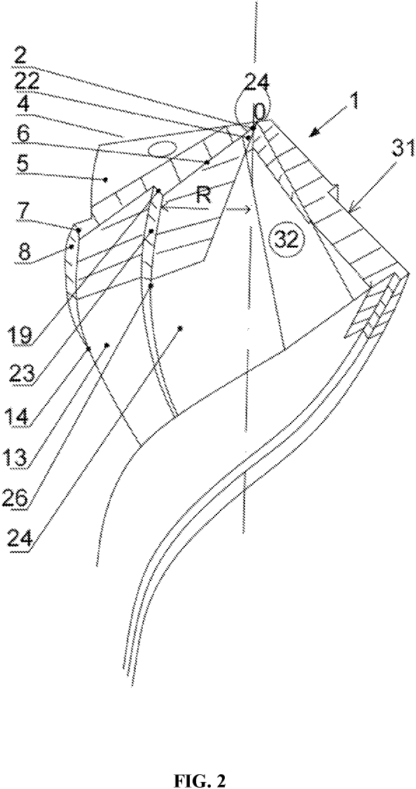

As shown in FIG. 2, the alloy tool bit twist drill 1 in the third embodiment of the present disclosure is comprehensively applied on the basis of the first embodiment and the second embodiment, and mainly relates to a drilling tool for machining. The alloy tool bit twist drill is integrally composed of a tool shank (not shown) comprising a taper shank or a straight shank, and a spiral tool body 4. Grooves are milled on the front spiral cutting surfaces of at least two spiral tool bodies 4, and an alloy tool bit 31 is arranged on the front spiral cutting surface integrally or in a connected mode. A cutting surface 13 at the front end in the rotating direction is integrally formed on the alloy tool bit 31 along the axial center of the alloy tool bit twist drill 1. The spiral cutting surfaces 13 integrally arranged on the two sides of the two spiral tool bodies 4 and the two cutting surfaces 13 integrally arranged with the alloy tool bit 31 are arranged in the same groove respectively.

The alloy cutter bit twist drill 1 is integrally provided with two spiral tool bodies 4. The surface of the alloy tool bit 31 of each spiral tool body 4 in the cutting direction is a cutting surface. The surface on the outer side of the backward cutting surface 13 in the rotating direction is a pair cutting surface 8. The cutting surface 13 is intersected with the pair cutting surface 8 to form a spiral cutting edge. The surface on the back side of the axial front end of the cutting surface 13 is a rear cutting surface 5. The rear cutting surfaces on at least two sides are intersected to form a chisel edge. The two ends of the chisel edge are chamfered to form a chamfer surface 22 and a chamfer edge 2. The cutting surface 13 is intersected with the rear cutting surface 5 to form a cutting edge 6. The pair cutting surface 8 is intersected with the rear cutting surface 5 to form a side edge 7. The spiral cutting edge 14 extends to the alloy tool bit 3 to form a pair cutting edge. The spiral pair cutting surface 8 extends to the alloy tool bit 31 to form a pair cutting surface 8 of the alloy tool bit 31.

A branch hole table 23 with millimeter strength convexly arranged in a stepwise manner and a branch cutting surface 24 are formed on the cutting surface 13 of the alloy tool bit 31 of the alloy tool bit twist drill 1 from the axial center to the center of the radius of the pair cutting surface 8 and on the spiral line extending along the spiral cutting edge in parallel at the center of the radius or near the radius. The branch hole 23 with millimeter strength is connected to the cutting surface 13 of the alloy tool bit 31 in a standing mode. The branch cutting surface 24 is intersected with the branch hole table 23 with millimeter strength to form a branch cutting edge 26. The branch cutting surface 24 and the branch hole table 23 with millimeter strength are intersected with the rear cutting surface 5 to form a cutting edge 6 and a side micro edge 19. The branch cutting surface 24 of the alloy tool bit 31 is from the axial center to the cutting surface 13 which is lager than or equal to one third of the radius of the alloy tool bit twist drill 1 and smaller than or equal to two thirds of the radius of the alloy tool bit twist drill 1.

In a contrast experiment carried out on a drilling machine, a twist drill with the diameter of 20.5 is used for the experiment. Heat treatment and production in the same batch are carried out at the same time on the same material of hard alloy. A drilling object is a forged and tempered gear finish turning machining value, the drilling depth is 35 mm, and blind holes are formed. Under the condition that the rotating speed and the feed amount of a twist drill with a common structure reach the limit, the rotating speed of the alloy tool bit twist drill 1 in the present disclosure can be increased by 40%, the feed amount is improved by 40%, and the comprehensive drilling efficiency is improved by 0.96 time. 412 drilling holes are formed in the twist drill 1 with a common structure. 5676 drilling holes are formed in the alloy tool bit twist drill 1. The number of drilling holes in the alloy tool bit twist drill 1 is increased by more than thirteen times compared with that of a twist drill with a common structure.

### Embodiment III

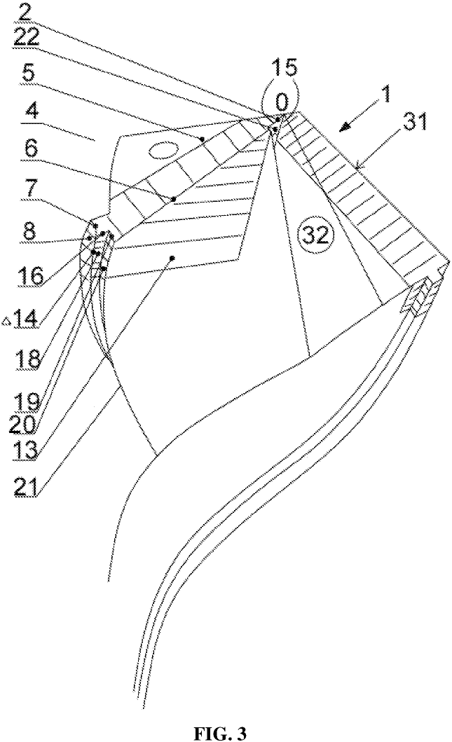

As shown in FIG. 3, the alloy tool bit twist drill 1 in the first embodiment of the present disclosure mainly relates to a drilling tool for machining. The alloy tool bit twist drill is integrally composed of a tool shank (not shown) comprising a taper shank or a straight shank, and a spiral tool body 4. Grooves are milled on the front spiral cutting surfaces of at least two spiral tool bodies 4, and an alloy tool bit 31 is arranged on the front spiral cutting surface integrally or in a connected mode. A cutting surface 13 at the front end in the rotating direction is integrally formed on the alloy tool bit 31 along the axial center of the alloy tool bit twist drill 1. The spiral cutting surfaces 13 integrally arranged on the two sides of the two spiral tool bodies 4 and the two cutting surfaces 13 integrally arranged with the alloy tool bit 31 are arranged in the same groove respectively.

The alloy cutter bit twist drill 1 is integrally provided with two spiral tool bodies 4. The surface of the alloy tool bit 31 of each spiral tool body 4 in the cutting direction is a cutting surface. The surface on the outer side of the backward cutting surface 13 in the rotating direction is a pair cutting surface 8. The cutting surface 13 is intersected with the pair cutting surface 8 to form a spiral cutting edge. The surface on the back side of the axial front end of the cutting surface 13 is a rear cutting surface 5. The rear cutting surfaces on at least two sides are intersected to form a chisel edge. The two ends of the chisel edge are chamfered to form a chamfer surface 22 and a chamfer edge 2. The cutting surface 13 is intersected with the rear cutting surface 5 to form a cutting edge 6. The pair cutting surface 8 is intersected with the rear cutting surface 5 to form a side edge 7. The spiral cutting edge extends to the alloy tool bit 31 to form a pair cutting edge. The spiral pair cutting surface 8 extends to the alloy tool bit 31 to form a pair cutting surface 8 of the alloy tool bit 31, or the pair cutting surface 8 of the alloy tool bit 31 protrudes out of the spiral pair cutting surface 8.

A micro cutting surface 18 with millimeter strength is concavely formed on the cutting surface 13 of the alloy tool bit 31 from the spiral cutting edge 17 along the outer periphery of the alloy tool bit 31 toward the axial center direction on the alloy tool bit twist drill 1. A micro-strengthening stress extension table 20 with millimeter strength is formed on the inner side of the micro cutting surface 18 of the alloy tool bit 31 of the alloy tool bit twist drill 1 in a standing mode. The micro cutting surface 18 with millimeter strength is intersected with the pair cutting surface 8 on the outer periphery to form a micro cutting edge 17 with millimeter strength. The micro cutting surface 18 with millimeter strength on the alloy tool bit 31 is intersected with the rear cutting surface 5 to form a cutting micro edge 16 with millimeter strength. The micro-strengthening stress extension table 20 with millimeter strength on the alloy tool bit 31 is intersected with the rear cutting surface 5 to form a side micro edge 19 with millimeter strength.

According to the structure, as drilling cutting is circular motion, centrifugal force is generated in the circular motion process. The cutting edge 6 forms a conduction carrier of the centrifugal force. The micro cutting edge 17 formed by intersecting cutting surface 13 with the adjacent spiral micro-strengthening stress extension table 16 and the side micro cutting edge 19 formed by intersecting with the micro cutting surface 18 with millimeter strength with the rear cutting surface are used for separating the cutting edge 6. The side micro edge 19 and the micro-strengthening stress extension table 20 form a composite positioning function. The cutting force is differentiated, and the overall cutting force is reduced. The stress action of the outer side cutting surface, namely the micro cutting edge 17 formed by intersecting the micro cutting surface 18 with the rear cutting surface, and the inner cutting edge 6 is reduced to the maximum extent. The temperature of the alloy tool bit 3131 is reduced. The stress of the cutting edge at the most easily damaged outer end of the tool is decomposed, so that the service life of the tool is prolonged, and high strength is always kept in the machining process.

In a contrast experiment carried out on a drilling machine, a twist drill with the diameter of 18.5 is used for the experiment. Heat treatment and production in the same batch are carried out at the same time on the same material of hard alloy. A drilling object is a forged and tempered gear finish turning machining value, the drilling depth is 35 mm, and blind holes are formed. Under the condition that the rotating speed and the feed amount of a twist drill with a common structure reach the limit, the rotating speed of the alloy tool bit twist drill 1 in the present disclosure can be increased by 40%, the feed amount is improved by 40%, and the comprehensive drilling efficiency is improved by 0.96 time. 526 drilling holes are formed in the alloy twist drill with a common structure. 6316 drilling holes are formed in the alloy tool bit twist drill 1. The number of drilling holes in the alloy tool bit twist drill 1 is increased by more than twelve times compared with that of a twist drill with a common structure.

### Embodiment IV

As shown in FIG. 1 and FIG. 2, the alloy tool bit twist drill 1 in the fourth embodiment of the present disclosure is comprehensively applied on the basis of the first embodiment to the third embodiment. A central stepped platform 10 with micro-strengthening technology is arranged in a standing mode and a central stepped surface 12 is convexly arranged on the inner side of the cutting surface 13 of the centering alloy tool bit twist drill 1 near the axial center O. The central stepped platform 10 with micro-strengthening technology is connected to the cutting surface 13 in a standing mode. The central stepped platform 10 with micro-strengthening technology is intersected with the central stepped surface 12 to form a central edge 11 with micro-strengthening technology. The central stepped surface 12 is arranged on the inner side of the central stepped platform 10 with micro-strengthening technology protruding in the rotating direction. The width of the central stepped surface 12 is smaller than or equal to one third of the radius of the centering alloy tool bit twist drill 1.

A branch hole table 23 with micro-strengthening technology convexly arranged in a stepwise manner and a branch cutting surface 24 are formed on the cutting surface 13 of the alloy tool bit 31 of the alloy tool bit twist drill 1 from the axial center to the center of the radius of the pair cutting surface 8 and on the spiral line extending along the spiral cutting edge in parallel at the center of the radius or near the radius integrally. The branch hole 23 with micro-strengthening technology is connected to the cutting surface 13 in a standing mode. The branch cutting surface 24 is intersected with the branch hole table 23 with micro-strengthening technology to form a branch cutting edge 26. The branch cutting surface 24 and the branch hole table 23 with micro-strengthening technology are intersected with the rear cutting surface 5 to form a cutting edge 6 and a side micro edge 19. The cutting surface 13 protruding on the inner side of the upper part of the branch hole table 23 with micro-strengthening technology is the branch cutting surface 24. The width of the branch cutting surface 24 is larger than or equal to one third of the radius of the centering alloy tool bit twist drill 1 and smaller than or equal to two thirds of the radius of the centering alloy tool bit twist drill 1.

The anti-abrasive central stepped platform 10 and the central stepped surface 12 are arranged on the cutting surface 13 of the alloy tool bit 31 of the centering alloy tool bit twist drill 1. The central edge 11 of the central stepped platform 10 and the central stepped surface 12 are used for decomposing the cutting force. The branch hole table 23 is used for strengthening the stability. The branch cutting edge 26, the branch cutting surface 24 and the notch edge 29 capable of breaking chip and decomposing the cutting force on the cutting edge extend toward the rear cutting surface to form the groove 30. Through the combined arrangement, the cutting efficiency and the service life of the centering alloy tool bit twist drill 1 can be guaranteed to the maximum extent.

### Embodiment V

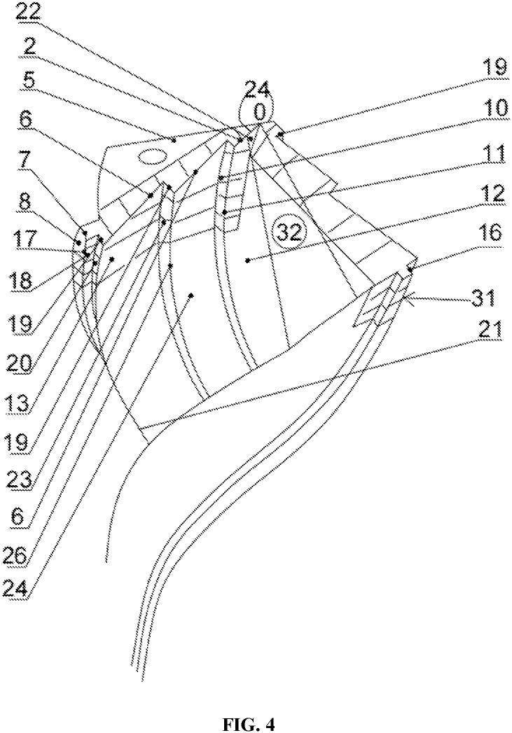

As shown in FIG. 1, FIG. 3 and FIG. 4, the alloy tool bit twist drill 1 in the fifth embodiment of the present disclosure is comprehensively applied on the basis of the first embodiment to the fourth embodiment. A central stepped platform 10 with micro-strengthening technology is arranged in a standing mode and a central stepped surface 12 is convexly arranged on the inner side of the spiral cutting surface 13 of the alloy tool bit 31 of the centering alloy tool bit twist drill 1 near the axial center O. The central stepped platform 10 with micro-strengthening technology is connected to the cutting surface 13 of the alloy tool bit 31 in a standing mode. The central stepped platform 10 with micro-strengthening technology is intersected with the central stepped surface 12 to form a central edge 11 with micro-strengthening technology. The cutting surface 13, the central stepped platform 10 with micro-strengthening technology and the front end of the central stepped surface 12 extending along the axial direction are intersected with the rear cutting surface 5 to form a side micro edge 19 and a cutting middle edge 3. The width of the central stepped surface 12 is smaller than or equal to one third of the radius of the centering alloy tool bit twist drill 1.

A micro cutting surface 18 with micro-strengthening technology is concavely formed on the cutting surface 13 of the alloy tool bit 31 from the spiral cutting edge 17 along the outer periphery of the alloy tool bit 31 toward the axial center direction on the alloy tool bit twist drill 1 integrally. A micro-strengthening stress extension table 20 with micro-strengthening technology is convexly formed on the inner side of the micro cutting surface 18 of the alloy tool bit 31 of the centering alloy tool bit twist drill 1. The micro cutting surface 18 with micro-strengthening technology on the alloy tool bit 31 is intersected with the pair cutting surface 8 on the outer periphery to form a micro cutting edge 17 with micro-strengthening technology. The micro cutting surface 18 with micro-strengthening technology on the alloy tool bit 31 is intersected with the rear cutting surface 5 to form a cutting micro edge 16 with micro-strengthening technology. The micro-strengthening stress extension table 20 with micro-strengthening technology on the alloy tool bit 31 is intersected with the rear cutting surface 5 to form a side micro edge 19 with micro-strengthening technology.

### Embodiment VI

As shown in FIG. 2 to FIG. 3 and FIG. 4, the alloy tool bit twist drill 1 in the sixth embodiment of the present disclosure is comprehensively applied on the basis of the first embodiment to the fifth embodiment. A branch hole table 23 with micro-strengthening convexly arranged in a stepwise manner and a branch cutting surface 24 are formed on the cutting surface 13 of the alloy tool bit twist drill 1 from the axial center to the center of the radius of the pair cutting surface 8 and on the spiral line extending along the spiral cutting edge in parallel at the center of the radius or near the radius. The branch hole 23 with micro-strengthening is connected to the cutting surface 13 in a standing mode. The branch cutting surface 24 is intersected with the branch hole table 23 with micro-strengthening to form a branch cutting edge 26. The branch cutting surface 24 and the branch hole table 23 with micro-strengthening are intersected with the rear cutting surface 5 to form a cutting edge 6 and a side micro edge 19. The width of the branch cutting surface 24 is lager than or equal to one third of the radius of the alloy tool bit twist drill 1 and smaller than or equal to two thirds of the radius of the alloy tool bit twist drill 1.

A micro cutting surface 18 with micro-strengthening technology is concavely formed on the cutting surface 13 of the alloy tool bit 31 from the spiral cutting edge 17 along the outer periphery of the alloy tool bit 31 toward the axial center direction on the alloy tool bit twist drill 1 integrally. A micro-strengthening stress extension table 20 with micro-strengthening technology is convexly formed on the inner side of the micro cutting surface 18 of the alloy tool bit 31 of the centering alloy tool bit twist drill 1. The micro cutting surface 18 with micro-strengthening technology is intersected with the pair cutting surface 8 on the outer periphery to form a micro cutting edge 17 with micro-strengthening technology. The micro cutting surface 18 with micro-strengthening technology is intersected with the rear cutting surface 5 to form a cutting micro edge 16 with micro-strengthening technology. The micro-strengthening stress extension table 20 with micro-strengthening technology is intersected with the rear cutting surface 5 to form a side micro edge 19 with micro-strengthening technology.

### Embodiment VII

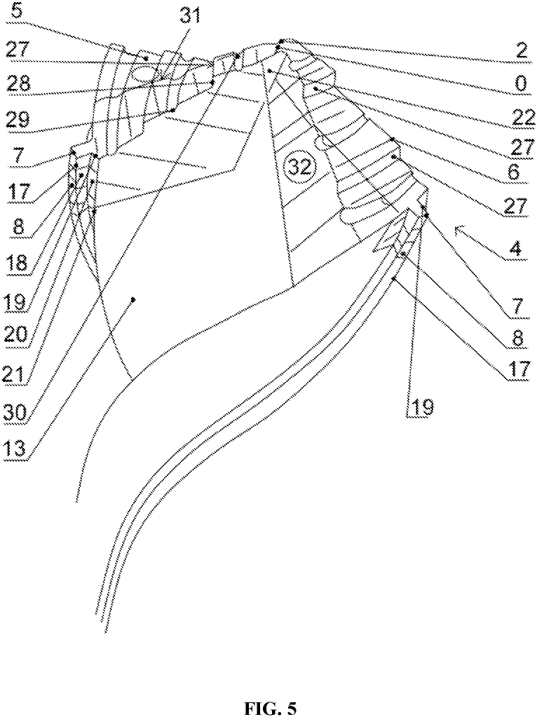

As shown in FIG. 1 to FIG. 5, the alloy tool bit twist drill 1 with combined edges in the fourth embodiment of the present disclosure is comprehensively applied on the basis of the first embodiment to the sixth embodiment. A central stepped platform 10 with millimeter strength is arranged in a standing mode and a central stepped surface 12 is convexly arranged on the inner side of the spiral cutting surface 13 of the alloy tool bit twist drill 1 with combined edges near the axial center O. The central stepped platform 10 with millimeter strength is connected to the cutting surface 13 in a standing mode. The central stepped platform 10 with millimeter strength is intersected with the central stepped surface 12 to form a central edge 11 with millimeter strength. The cutting surface 13, the central stepped platform 10 with millimeter strength and the front end of the central stepped surface 12 extending along the axial direction are intersected with the rear cutting surface 5 to form a side micro edge 19 and a cutting middle edge 3. The central stepped surface 12 is arranged on the inner side of the central stepped platform 10 with millimeter strength protruding in the rotating direction.

A branch hole table 23 with millimeter strength convexly arranged in a stepwise manner and a branch cutting surface 24 are formed on the cutting surface 13 of the alloy tool bit twist drill 1 with combined edges from the axial center to the center of the radius of the pair cutting surface 8 and on the spiral line extending along the spiral cutting edge in parallel at the center of the radius or near the radius. The branch hole 23 with millimeter strength is connected to the cutting surface 13 in a standing mode. The branch cutting surface 24 is intersected with the branch hole table 23 with millimeter strength to form a branch cutting edge 26. The branch cutting surface 24 and the branch hole table 23 with millimeter strength are intersected with the rear cutting surface 5 to form a cutting edge 6 and a side micro edge 19. The cutting surface 13 protruding on the inner side of the upper part of the branch hole table 23 with micro-strengthening technology is the branch cutting surface 24.

A micro cutting surface 18 with millimeter strength is concavely formed on the cutting surface 13 of the alloy tool bit 31 from the spiral cutting edge 17 along the outer periphery of the alloy tool bit 31 toward the axial center direction on the alloy tool bit twist drill 1 with combined edges. A micro-strengthening stress extension table 20 with millimeter strength is formed on the inner side of the micro cutting surface 18 of the alloy tool bit 31 of the alloy tool bit twist drill 1 with combined edges in a standing mode. The micro cutting surface 18 with millimeter strength is intersected with the pair cutting surface 8 on the outer periphery to form a micro cutting edge 17 with millimeter strength. The micro cutting surface 18 with millimeter strength is intersected with the rear cutting surface 5 to form a cutting micro edge 16 with millimeter strength. The micro-strengthening stress extension table 20 with millimeter strength is intersected with the rear cutting surface 5 to form a side micro edge 19 with millimeter strength.

As shown in FIG. 2 to FIG. 3 and FIG. 4, the embodiment of the present disclosure is comprehensively applied on the basis of the first embodiment to the fifth embodiment. At least one standing step 27 and at least one protruding rear cutting surface 5 are arranged on the rear cutting surface 5 where the alloy tool bit of the alloy tool bit twist drill is located from the axial center in such a manner that the height of the rear cutting surface 5 in the direction of an outer side edge 7 is reduced. The standing step 27 is intersected with the cutting surface 13 at the front end in the rotating direction to form at least one standing step edge 28. The at least one protruding rear cutting surface 5 is intersected with the cutting surface 13 at the front end in the rotating direction to form at least one protruding cutting edge 6.

Or, more standing steps 27 and more protruding rear cutting surfaces 5 are arranged on the rear cutting surface 5 where the alloy tool bit of the alloy tool bit twist drill is located from the axial center in such a manner that the height of the rear cutting surface 5 in the direction of an outer side edge 7 is reduced. The more standing steps 27 are intersected with the cutting surface 13 at the front end in the rotating direction to form more standing step edges 28. The more protruding rear cutting surfaces 5 are intersected with the cutting surface 13 at the front end in the rotating direction to form more protruding cutting edges 6.

Or, at least one notch edge 29 is arranged on the cutting edge 6 of the alloy tool bit 31 of the alloy tool bit twist drill 1, and the notch edge 29 extends toward the rear cutting surface to form a groove 30.

Or, more notch edges 29 can be arranged on the cutting edge 6 of the alloy tool bit 31 of the alloy tool bit twist drill 1, and each notch edge 29 extends toward the rear cutting surface to form a groove 30.

Or, at least one or more standing steps 27 and at least one or more protruding rear cutting surfaces 5 are arranged on the rear cutting surface 5 where the alloy tool bit of the alloy tool bit twist drill is located from the axial center in such a manner that the height of the rear cutting surface 5 in the direction of an outer side edge 7 is reduced. The at least one or more standing steps 27 are intersected with the cutting surface 13 at the front end in the rotating direction to form at least one or more standing step edges 28. The at least one or protruding rear cutting surfaces 5 are intersected with the cutting surface 13 to form at least one protruding cutting edges 6. At least one or more notch edges 29 are arranged on the at least one or more stepwise alloy tool bit cutting edges 6. Each notch edge extends toward the rear cutting surface to form a groove 30.

In a contrast experiment carried out on a drilling machine, a twist drill with the diameter of 10.5 is used for the experiment. Heat treatment and production in the same batch are carried out at the same time on the same material of hard alloy. A drilling object is a forged and tempered gear finish turning machining value, the drilling depth is 35 mm, and blind holes are formed. Under the condition that the rotating speed and the feed amount of a twist drill with a common structure reach the limit, the rotating speed of the alloy tool bit twist drill in the present disclosure can be increased by 40%, the feed amount is improved by 40%, and the comprehensive drilling efficiency is improved by 0.96 time. 526 drilling holes are formed in the alloy twist drill with a common structure. 5316 drilling holes are formed in the alloy tool bit twist drill with combined edges. The number of drilling holes in the alloy tool bit twist drill is increased by more than ten times compared with that of a twist drill with a common structure.

According to experimental results, the use efficiency of the twist drill is obviously and greatly improved, the service life of the twist drill is obviously and greatly prolonged, and various structures of the twist drill are proved to be effective modes for prolonging the service life and improving the efficiency.

The alloy tool bit twist drill is comprehensively applied on the basis of the first embodiment to the seventh embodiment. The included angle formed by intersecting the cutting edge 6 of the alloy tool bit 31 on the outermost side of the alloy tool bit twist drill 1 with the spiral pair cutting edge 14 is an acute angle; or the included angle formed by intersecting the cutting edge 31 of the alloy tool bit 31 on the outermost side of the alloy tool bit twist drill with the spiral pair cutting edge 14 is a right angle; or the included angle formed by intersecting the cutting edge 6 of the alloy tool bit 31 on the outermost side of the alloy tool bit twist drill with the spiral pair cutting edge 14 is an obtuse angle.

The rear cutting surfaces 5 on the two sides of the alloy tool bit 31 of the alloy tool bit twist drill 1 are intersected in the axial center to form a chisel edge 3, and a chamfer surface 22, a chamfer edge 24 and a shrunk chisel edge are formed through chamfering.

Or, the rear cutting surfaces 5 on the two sides of the alloy tool bit 31 of the alloy tool bit twist drill 1 are intersected in the axial center to form a chisel edge 3, and a chamfer surface 22, a chamfer edge 24 and a sharp edge O without a chisel edge are formed through chamfering.

Cooling holes 32 are integrally formed in a tool shank and a spiral tool body of the alloy tool bit twist drill 1.

A tool shank (not shown) of the alloy tool bit twist drill 1 is a straight shank; or a tool shank (not shown) of the alloy tool bit twist drill 1 is a taper shank.

Although the tool with two spiral tool bodies 4 has been described above as an example, the tool in the present disclosure also can be provided with a plurality of spiral tool bodies 4, and a combination of the structure in the embodiments and other various forms thereof may be used on each spiral tool body 4.

The preferred embodiments described above are illustrative and not restrictive. The present disclosure may be implemented and embodied in other ways without departing from the spirit and essential characteristics of the present disclosure, the scope of which is defined by the claims. All variations that come within the scope of the claims are intended to fall within the scope of the present disclosure.

1. An alloy tool bit twist drill, comprising a tool shank, a spiral tool body and an alloy tool bit, wherein the alloy tool bit twist drill is integrally provided with at least two spiral tool bodies, the surface of each spiral tool body in the cutting direction is a spiral cutting surface, the surface on the outer side of the backward spiral cutting surface in the rotating direction is a spiral pair cutting surface, the spiral cutting surface is intersected with the spiral pair cutting surface to form a spiral cutting edge, the surface on the back side of the axial front end of the spiral cutting surface is a rear cutting surface, the rear cutting surfaces on at least two sides are intersected to form a chisel edge, the spiral cutting surface is intersected with the rear cutting surface to form a cutting edge, and the spiral pair cutting surface is intersected with the rear cutting surface to form a side edge;
the alloy tool bit twist drill is integrally composed of the tool shank and the spiral tool body, a groove is milled on the front spiral cutting surface of the spiral tool body, an alloy tool bit is integrally arranged on the front spiral cutting surface, the spiral cutting surfaces on the two sides and a cutting surface of the alloy tool bit are arranged in the same groove respectively, the spiral cutting edge extends to the alloy tool bit to form a pair cutting edge, and the spiral pair cutting surface extends to the alloy tool bit to form a pair cutting surface;
a central stepped platform is arranged on the cutting surface near the axial center of the alloy tool bit of the alloy tool bit twist drill in a standing mode; a central stepped surface is arranged on the inner side of the central stepped platform protruding in the rotating direction; the central stepped platform is intersected with the rear cutting surface to form a side micro edge; the central stepped platform is intersected with the central stepped surface to form a central edge; and
the width of the central stepped surface on the alloy tool bit is from the axial center to the cutting surface which is smaller than or equal to one third of the radius of the alloy tool bit twist drill.

2. The alloy tool bit twist drill according to claim 1,
wherein a branch hole table is concavely arranged on the cutting surface of the pair cutting edge on the alloy tool bit of the alloy tool bit twist drill in a stepwise manner from the axial center to the outer periphery; the inner side of the branch hole table protrudes to form a branch cutting surface, the branch cutting surface is intersected with the rear cutting surface to form the cutting edge; the branch hole table is intersected with the rear cutting surface to form a side micro edge; the branch hole table is intersected with the cutting surface protruding on the inner side to form a branch cutting edge; and
the branch cutting surface is from the axial center to the cutting surface which is larger than or equal to one third of the radius of the alloy tool bit twist drill and smaller than or equal to two thirds of the radius of the alloy tool bit twist drill.

3. The alloy tool bit twist drill according to claim 1,
wherein a micro cutting surface is concavely formed on the cutting surface of the alloy tool bit from the pair cutting edge toward the axial center direction on the cutting surface of the alloy tool bit of the alloy tool bit twist drill; a micro-strengthening stress extension table is formed on the inner side of the micro cutting surface in a standing mode; the micro cutting surface is intersected with the pair cutting surface on the outer periphery to form a micro cutting edge; the micro cutting surface is intersected with the rear cutting surface to form a cutting micro edge; and the micro-strengthening stress extension table is intersected with the rear cutting surface to form a side micro edge.

4. The alloy tool bit twist drill according to claim 1,
wherein the central stepped platform is intersected with the central stepped surface to form a central edge; a branch hole table is concavely arranged on the cutting surface of the pair cutting edge on the alloy tool bit of the alloy tool bit twist drill in a stepwise manner from the axial center to the outer periphery integrally; the inner side of the branch hole table protrudes to form a branch cutting surface, the branch cutting surface is intersected with the rear cutting surface to form the cutting edge; the branch hole table is intersected with the rear cutting surface to form a side micro edge; the branch hole table is intersected with the cutting surface protruding on the inner side to form a branch cutting edge.

5. The alloy tool bit twist drill according to claim 1,
wherein a micro cutting surface is concavely formed on the cutting surface of the alloy tool bit from the pair cutting edge toward the axial center direction on the cutting surface of the alloy tool bit of the alloy tool bit twist drill integrally; a micro-strengthening stress extension table is formed on the inner side of the micro cutting surface in a standing mode; the micro cutting surface is intersected with the pair cutting surface on the outer periphery to form a micro cutting edge; the micro cutting surface is intersected with the rear cutting surface to form a cutting micro edge; and the micro-strengthening stress extension table is intersected with the rear cutting surface to form a side micro edge.

6. The alloy tool bit twist drill according to claim 1,
wherein a branch hole table is concavely arranged on the cutting surface of the pair cutting edge on the alloy tool bit of the alloy tool bit twist drill in a stepwise manner from the axial center to the outer periphery; the inner side of the branch hole table protrudes to form a branch cutting surface, the branch cutting surface is intersected with the rear cutting surface to form the cutting edge; the branch hole table is intersected with the rear cutting surface to form a side micro edge; the branch hole table is intersected with the cutting surface protruding on the inner side to form a branch cutting edge; a micro cutting surface is concavely formed on the cutting surface of the alloy tool bit from the pair cutting edge toward the axial center direction on the cutting surface of the alloy tool bit of the alloy tool bit twist drill integrally; a micro-strengthening stress extension table is formed on the inner side of the micro cutting surface in a standing mode; the micro cutting surface is intersected with the pair cutting surface on the outer periphery to form a micro cutting edge; the micro cutting surface is intersected with the rear cutting surface to form a cutting micro edge; and the micro-strengthening stress extension table is intersected with the rear cutting surface to form a side micro edge.

7. The alloy tool bit twist drill according to claim 1,
wherein a branch hole table is concavely arranged on the cutting surface of the pair cutting edge on the alloy tool bit of the alloy tool bit twist drill in a stepwise manner from the axial center to the outer periphery integrally; the inner side of the branch hole table protrudes to form a branch cutting surface, the branch cutting surface is intersected with the rear cutting surface to form the cutting edge; the branch hole table is intersected with the rear cutting surface to form a side micro edge; the branch hole table is intersected with the cutting surface protruding on the inner side to form a branch cutting edge; a micro cutting surface is concavely formed on the cutting surface of the alloy tool bit from the pair cutting edge toward the axial center direction on the cutting surface of the alloy tool bit of the alloy tool bit twist drill integrally; a micro-strengthening stress extension table is formed on the inner side of the micro cutting surface in a standing mode; the micro cutting surface is intersected with the pair cutting surface on the outer periphery to form a micro cutting edge; the micro cutting surface is intersected with the rear cutting surface to form a cutting micro edge; and the micro-strengthening stress extension table is intersected with the rear cutting surface to form a side micro edge.

8. The alloy tool bit twist drill according to claim 1, wherein
at least one or more notch edges are arranged on an alloy tool bit cutting edge of the alloy tool bit twist drill; and each notch edge extends toward the rear cutting surface to form a groove.

9. The alloy tool bit twist drill according to claim 1, wherein
at least one or more standing steps and at least one or more protruding rear cutting surfaces are arranged on the rear cutting surface where the alloy tool bit of the alloy tool bit twist drill is located from the axial center in such a manner that the height of the rear cutting surface in the direction of an outer side edge is reduced, the standing step is intersected with the cutting surface at the front end in the rotating direction to form at least one or more standing step edges, and the at least one or more protruding rear cutting surfaces are intersected with the cutting surface at the front end in the rotating direction to form at least one or more protruding cutting edges.

10. The alloy tool bit twist drill according to claim 1, wherein
at least one or more standing steps and at least one or more protruding rear cutting surfaces are arranged on the rear cutting surface where the alloy tool bit of the alloy tool bit twist drill is located from the axial center in such a manner that the height of the rear cutting surface in the direction of an outer side edge is reduced, the at least one or more standing steps are intersected with the cutting surface at the front end in the rotating direction to form at least one or more standing step edges, and the at least one or protruding rear cutting surfaces are intersected with the cutting surface to form at least one protruding cutting edges; and at least one or more notch edges are arranged on the at least one or more stepwise alloy tool bit cutting edges, and each notch edge extends toward the rear cutting surface to form a groove.

11. The alloy tool bit twist drill according to claim 1, wherein
the rear cutting surfaces on the two sides of the front end of the alloy tool bit of the alloy tool bit twist drill are intersected at the axial center to form a chamfer surface, a chamfer edge and a chisel edge.

12. The alloy tool bit twist drill according to claim 1, wherein
the rear cutting surfaces on the two sides of the front end of the alloy tool bit of the alloy tool bit twist drill are intersected at the axial center to form a chamfer surface, a chamfer edge and a sharp edge without a chisel edge.

13. The alloy tool bit twist drill according to claim 1, wherein
cooling holes are integrally formed in a tool shank and a spiral tool body of the alloy tool bit twist drill.

14. The alloy tool bit twist drill according to claim 1, wherein
the included angle formed by intersecting the cutting edge on the outermost side of the alloy tool bit of the alloy tool bit twist drill with the spiral pair cutting edge is an acute angle; or the included angle formed by intersecting the cutting edge on the outermost side of the alloy tool bit of the alloy tool bit twist drill with the spiral pair cutting edge is a right angle; or the included angle formed by intersecting the cutting edge on the outermost side of the alloy tool bit of the alloy tool bit twist drill with the spiral pair cutting edge is an obtuse angle.

15. The alloy tool bit twist drill according to claim 1, wherein
a tool shank of the alloy tool bit twist drill is a straight shank; or a tool shank of the alloy tool bit twist drill is a taper shank, the width of a central stepped surface on the alloy tool bit is smaller than or equal to one third of the radius of the alloy tool bit twist drill, and the width of a branch cutting surface of the alloy tool bit is larger than or equal to one third of the radius of the alloy tool bit twist drill and smaller than or equal to two thirds of the radius of the alloy tool bit twist drill.

16-17. (canceled)

18. The alloy tool bit twist drill according to claim 2, wherein
at least one or more notch edges are arranged on an alloy tool bit cutting edge of the alloy tool bit twist drill; and each notch edge extends toward the rear cutting surface to form a groove.

19. The alloy tool bit twist drill according to claim 3, wherein
at least one or more notch edges are arranged on an alloy tool bit cutting edge of the alloy tool bit twist drill; and each notch edge extends toward the rear cutting surface to form a groove.

20. The alloy tool bit twist drill according to claim 4, wherein
at least one or more notch edges are arranged on an alloy tool bit cutting edge of the alloy tool bit twist drill; and each notch edge extends toward the rear cutting surface to form a groove.

21. The alloy tool bit twist drill according to claim 5, wherein
at least one or more notch edges are arranged on an alloy tool bit cutting edge of the alloy tool bit twist drill; and each notch edge extends toward the rear cutting surface to form a groove.

22. The alloy tool bit twist drill according to claim 6, wherein
at least one or more notch edges are arranged on an alloy tool bit cutting edge of the alloy tool bit twist drill; and each notch edge extends toward the rear cutting surface to form a groove.
